(19) United States
(12) Patent Application Publication
(10) Pub. No.: US 2006/0001605 A1
(43) Pub. Date: Jan. 5, 2006

(54) Plasma display device and driving method for use in plasma display device

(75) Inventor: Takashi Furutani, Izumi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Pioneer Plasma Display Corporation, Izumi (JP)

(21) Appl. No.: 11/099,695

(22) Filed: Apr. 6, 2005

(30) Foreign Application Priority Data
Jul. 4, 2004 (JP) 2004-113691

(51) Int. Cl. G09G 3/28

(52) U.S. Cl. 345/63

(57) ABSTRACT

A plasma display device which has sufficient levels of gradation for displaying a dark image, and a sufficiently low display luminance for a black level. A unit cell is composed of a large sub-cell 37 and a small sub-cell 38, and the luminance level of the small sub-cell 38 is set to 1/16, ⅛, ¼, or ½ from one sub-field to another, so that the gradation of a dark image is smoothly displayed. Also, since the light emission luminance is sufficiently reduced when black is displayed by producing a priming discharge in the small sub-cell 38, a satisfactory image is displayed.

### BACKGROUND OF THE INVENTION

1. Field of the Invention

The present invention relates to a plasma display device and a driving method for use in the plasma display device, and more particularly, to a plasma display device and a driving method for use in the plasma display device, which are suitable for use in displaying the gradation of a dark image.

2. Description of the Related Art

A plasma display device mainly including a plasma display panel (hereinafter called the “PDP”) has a lot of advantages over displays such as CRT (Cathode Ray Tube) and a liquid crystal display device which have been conventionally used in wide applications, including less flickering, a large display contrast ratio, a flat shape, the ability to display a large screen, a higher response speed, and the like. For this reason, the plasma display devices have been increasingly used in recent years as display devices such as public display devices, large-sized flat televisions, and the like.

The plasma display devices are roughly classified, according to the operation scheme, into an AC type one in which display electrodes of a PDP (surface discharge electrode pairs each comprised of a scanning electrode and a discharge sustain electrode, later described) are covered with a transparent dielectric layer, and are indirectly operated in a AC discharge state, and a DC type one in which the display electrodes are exposed to a discharge space, and are driven in a DC discharge state. Particularly, the former is widely used in recent years because it can readily provide larger screens, as mentioned above, in a relatively simple structure. In such a PDP, a front substrate and a back substrate, both of which comprise transparent electrodes made of glass or the like, are disposed to oppose each other such that a discharge gas space is formed between both the substrates, in which a plasma is generated.

Also, a frequently used AC-type PDP employs a three-electrode surface discharge configuration. In this three-electrode surface discharge type PDP, surface discharge electrodes (also called “display electrodes” or “row electrodes” composed of a scanning electrode and a discharge sustain electrode (generally called “common electrodes” because they are electrically coupled) are disposed in parallel along a horizontal direction (row direction) on the inner surface of the front substrate of the pair of substrates which form unit cells (discharge cells) of the PDP. Also, column electrodes comprised of data electrodes (also called “address electrodes”) are disposed in a vertical direction (column direction) so as to be orthogonal to the row electrodes on the inner surface of the back substrate. This PDP is most widely employed because of its long lifetime since high-energy ions generated during a surface discharge produced in the discharge space on the front substrate side hardly impact on fluorescent layers formed on the inner side of the back substrate. Also, the fluorescent layers are composed of a red (R), a blue (B), and a green (G) fluorescent layer deposited inside the back substrate, and can emit light in multiple colors in accordance with an additive color mixture.

FIG. 1 is a perspective view showing the configuration of a main portion of the three-electrode surface discharge type PDP mentioned above.

As shown in the figure, in this PDP, a front substrate (first substrate) 1 and a back substrate (second substrate) 2 are disposed to oppose each other, such that a discharge gas space 3 is formed between these substrates. The front substrate 1 comprises an insulating substrate 4, a scanning electrode 5, a discharge sustain electrode 6, a discharge gap 7, a transparent dielectric layer 8, and a protection layer 9. The insulating substrate 4 is made of a transparent material such as soda lime glass. The scanning electrode 5 and discharge sustain electrode 6 are disposed on the inner surface of the insulating substrate 4 in parallel with each other in a row direction H, are formed to oppose each other across the discharge gap 7, and make up a pair of surface discharge electrodes.

The scanning electrode 5 is comprised of a transparent electrode 5a and a bus electrode (also called the “trace electrode”) 5b. The transparent electrode 5a is made of ITO (Indium Tin Oxide, an electrically conductive transparent thin film) or the like. The bus electrode 5b is made of a metal material such as Al (aluminum), Cu (copper), Ag (silver) or the like, and is formed to partially overlap the transparent electrode 5a to reduce the resistance of the transparent electrode 5a. The discharge sustain electrode 6 in turn is comprised of a transparent electrode 6a and a bus electrode 6b. The transparent electrode 6a is made of ITO or the like, similar to the transparent electrode 5a, while the bus electrode 6b is made of a metal material similar to the bus electrode 5b, and is formed to partially overlap the transparent electrode 6a to reduce the resistance of the transparent electrode 6a. The transparent dielectric layer 8, which is made of lead containing flit glass or the like, covers the scanning electrode 5 and discharge sustain electrode 6. The protection layer 9, which is made of MgO (magnesium oxide) or the like, protects the dielectric layer 8 from discharges.

On the other hand, the back substrate 2 comprises an insulating substrate 12, a data electrode (also called the “address electrode”) 13, a white dielectric layer 14, partitions 15, and a fluorescent layer 16. The insulating substrate 12 is made of a transparent material such as soda lime glass or the like. The data electrode 13 is made of Al (aluminum), Cu (copper), Ag (silver) or the like, and is formed on the inner surface of the insulating substrate 12 in a column direction V perpendicular to the row direction H. The white dielectric layer 14 is made of lead containing flit glass or the like, and covers the data electrode 13. The partitions 15 are made of lead containing flit glass or the like, and are formed in parallel crosses in the row direction H and column direction V for partitioning respective display cells. Then, the partitions 15 ensure the discharge gas space 3 which is filled with one of discharge gases such as He (helium), Ne (neon), Xe (xenon) and the like, or a mixture of such discharge gases. The fluorescent layer 16 is formed at a position at which it covers the bottoms and wall surfaces of the partitions 15, and is divided into a red fluorescent layer, a green fluorescent layer, and a blue fluorescent layer which convert ultraviolet rays generated by a discharge of a discharge gas into visible light P. Then, unit cells as shown in FIG. 1 are arranged in a matrix shape in the row direction H and column direction V to make up the PDP.

The front substrate 1 and back substrate 2 are fixed in opposition to each other across a gap of approximately 100 μm. The insulating substrate 12, which comprises the back substrate 2, is formed with an air hole at a predetermined location, and on the outer surface of the insulating substrate 12, a vent pipe, not shown, is attached in alignment to the air hole in a sealing state. The end of the vent pipe opposite to the end attached to the insulating substrate 12 is initially opened, so that the vent pipe is connected to a exhaust/gas filling apparatus through the open end. Then, after the discharge gas space 3 has been exhausted into a vacuum by the exhaust/gas filling apparatus, the discharge gas space 3 is filled with a discharge gas. After the discharge gas has been filled in the discharge gas space 3, the vent pipe is thermally chipped on to close the open end. In this way, the discharge gas space 3 is filled with the discharge gas, thus completing the PDP. A plasma display device which includes the PDP as a main component uses three display cells (display cells in red (R), green (G), and blue (B)) to make up one pixel for color display, and has a pixel per display cell for monochrome display.

FIG. 2 is a plan view generally showing the configuration of electrodes arranged in the PDP of FIG. 1.

As shown in FIG. 2, this PDP has surface discharge electrodes comprised of N scanning electrodes (S₁, S₂, S_{N}) and discharge sustain electrodes 5 (C) disposed in parallel with each other in the row direction on the inner surface of the front substrate 1 in FIG. 1, and M data electrodes 13 (D₁, D₂, . . . , D_{M}) disposed on the inner surface of the back substrate 2 along the column direction V so as to be perpendicular to the surface discharge electrodes. Then, in each of intersecting regions of the surface discharge electrodes with the data electrodes 13, a single unit cell 20 (hereinafter simply called the “cell” as well) is formed, such that cells are formed in matrix in the row direction H and column direction V. For monochrome display, one pixel is comprised of one cell, while for color display, one pixel is formed of three cells (red (R), green (G), and blue (B) light emission cells).

FIG. 3 is a plan view generally showing the configuration of part of the electrodes arranged in the PDP of FIG. 2.

Cells 20ₙ₋₁, 20ₙ, 20ₙ₊₁ are formed adjacent to each other in the column direction V, as shown in FIG. 3. Also, the cell 20ₙ positioned in the middle, for example, is formed in an intersecting region of three electrodes, i.e., a scanning electrode Sn and a discharge sustain electrode 6 (C) in parallel with each other, and a data electrode 13 (Dₘ, where m=1, 2, . . . , M) perpendicular to these electrodes.

In this PDP, one field FT, which is a period for displaying one screen (for example, 1/60 seconds), is composed of a plurality of sub-fields TS in combination. Here, each sub-field is provided for halftone display, and is made up of a pre-discharge period T1, a scanning period (also called an “address discharge period”) T2, and a discharge sustain period T3. For driving the PDP, in the scanning period T2, a scanning pulse P8 is applied to each scanning electrode 5 on the front substrate 1, and simultaneously, a data pulse P9 is applied to the data electrodes 13 on the back substrate 2 to produce a write discharge for selecting cells which should be driven to discharge (emit light).

Subsequently, in the discharge sustain period T3, a sustain discharge is produced by a surface discharge between the scanning electrode 5 and the discharge sustain electrode 6 in the selected cells. The presence or absence of the discharge is determined by forming or erasing a charge, called a “wall charge,” on the transparent dielectric layer 8 formed to cover the display electrodes of the front substrate 1 to control the amount of this charge. Here, the distinction of a discharge cell (light emitting cell) from a non-discharge cell (non-light emitting cell) is made using two types of data pulses which have different voltages from each other when a write discharge is produced in the scanning period T2. For example, in the scanning period T2 in FIG. 4, a cell which is applied with a data pulse P9 at several tens of volts emits light, while a cell which is applied with zero volt, i.e., which is not applied with the data pulse, does not emit light.

In the discharge sustain period T3, discharge sustain pulses P10 are alternately applied between the scanning electrodes 5 and the discharge sustain electrodes 6 of all the cells, causing a sustain discharge to be produced only in those cells which have emitted light in the scanning period T2, thus making a display. After the sustain discharge, in the pre-discharge period T1, a sustain erasure pulse P5 is applied to all the cells which have emitted light to produce a sustain erasure discharge for erasing the wall charges formed by the sustain discharge, for preparation of a write discharge which is produced in the next sub-field. Also, in the pre-discharge period T1, for facilitating the next write discharge, priming pulses P6, P7 are applied to all the cells, subsequent to the sustain erasure discharge, to produce a priming discharge. In the foregoing, the write discharge in the scanning period T2 and the sustain discharge in the discharge sustain period T3 have been described prior to the sustain erasure discharge and priming discharge in the pre-discharge period T1 for facilitating the understanding of the description, but the respective discharges are produced in the order shown in FIG. 4 in one sub-field TS.

FIG. 5 is a diagram for explaining the principle of a halftone display method used for the PDP of FIG. 4, where the horizontal axis represents the time, and the vertical axis represents numbers, not shown, of the scanning electrodes in the PDP.

In this PDP, as shown in FIG. 5, one field TF is divided into eight sub-fields TS1, TS2, . . . , TS8 which are weighted based on gradation levels, and each sub-field is again divided into a pre-discharge period T1, a scanning period T2, and discharge sustain period T3. Shading in each scanning period T2 represents the timing at which a scanning pulse is applied to each scanning electrode 5. A write discharge is produced when this scanning pulse and a data pulse applied to the data electrode 13 are both applied simultaneously. The discharge sustain period T3 is a period in which cells emit light for display.

In the discharge sustain period T3, a discharge sustain pulse is alternately applied to the scanning electrode and discharge sustain electrode 6, causing cells which have experienced a discharge in the scanning period T2 to emit light at an intensity in accordance with the length of the discharge sustain period T3 (i.e., the number of discharge sustain pulses). In FIG. 5, the respective lengths of the discharge sustain periods T2 in the sub-fields TS1, TS2, . . . , TS8 are set in a ratio of 1:2:4:8:16:32:64:128, so that an image is displayed at 256 levels of gradation (0-255) by combining light emissions in these discharge sustain periods T3. For example, when an image is displayed at the 100th level of gradation, the PDP is controlled to emit light in the sub-field TS1 (gradation level: 4), sub-field TS6 (gradation level: 32), and sub-field TS7 (gradation level: 64). When the frequency of the discharge sustain pulse in the discharge sustain period T3 becomes higher, the number of times of light emissions is increased as a whole, resulting in a higher light emission luminance. However, the discharge sustain pulse at a higher frequency causes larger power consumption of the PDP. Also, while eight sub-fields are set for providing displays at 256 levels of gradation in this example, nine or more sub-fields may be set for redundancy.

In recent years, the luminance provided by each discharge sustain pulse has been improved by optimizing the cell structure of the PDP, discharge gas, and fluorescent material. This effectively improves the luminance of a display screen of a plasma display device, and also improves the contrast in the light. On the other hand, since the halftone display of the plasma display device is determined by the number of discharge sustain pulses, the luminance when the lowest level of gradation next to a black level is selected will not be lower than the luminance resulting from one discharge sustain pulse. In other words, the difference between the black luminance level and the next luminance level appears in correspondence to one cycle of the discharge sustain pulse. Therefore, as the luminance provided by each discharge sustain pulse is improved, a halftone display does not appear smooth in dark regions, failing to produce a satisfactory image. This problem has come to the surface.

An increase in luminance provided by one discharge sustain pulse means a like increase in luminance produced by the priming discharge in the pre-discharge period T1 in FIG. 5. Since this priming discharge is also produced when black is displayed, an increase in luminance produced by the priming discharge causes a higher luminance of the black level, failing to produce a satisfactory image.

Solutions for these problems, i.e., insufficient levels of gradation when a dark image is displayed, and an excessively high luminance for the black level are described in the following documents.

In a plasma display panel described in Laid-open Japanese Patent Application No. 2000-100333 (abstract and FIG. 1) (Patent Document 1), R, G, B cells are each divided into several sub-cells, and the sub-cells surrounded by ribs (partitions) coated with a fluorescent material are driven to emit light or erased on an individual basis to change the number of sub-cells which emit light every sub-field, thus providing required levels of gradation.

In a plasma display panel described in Laid-open Japanese Patent Application No. 2001-15039 (abstract and FIG. 1) (Patent Document 2), pixels are arranged in matrix between a pair of substrates, wherein the pixels are defined by partitions disposed on one of the substrates, and each pixel is divided into a plurality of sub-pixels. The area of each divided sub-pixel is again divided into a plurality of sub-areas by barriers disposed on one of the pair of substrates, and electrodes are disposed for producing a discharge in the areas of these divided sub-pixels. In this way, required levels of gradation can be produced.

In a plasma display panel described in Laid-open Japanese Patent Application No. 2003-86108 (abstract and FIGS. 1 to 5) (Patent Document 3), a unit light emission area is composed of a display discharge cell and a reset-and-address discharge cell. These display discharge cell and reset-and-address discharge cell are in communication with each other, and a light absorbing layer is formed in a portion opposite to a display surface side of the reset-and-address discharge cell. In such a structure, a priming discharge is produced only in the reset-and-address discharge cell, and light emission caused by the priming discharge is hidden by the light absorbing layer, resulting in a reduction in the luminance of the black level.

However, the conventional plasma display panels described above have the following problems.

Specifically, in the plasma display panels described in Patent Document 1 or Patent Document 2, a larger number of electrodes must be provided than before for independently emitting light from individual divided cells. This leads to a problem of a complicated configuration of a device and an inevitable increase in manufacturing cost. Also, the problem of an increased luminance for the black level is left unsolved. The number of times of priming discharges may be reduced in order to reduce the luminance for the black level. Specifically, the priming discharge may not be produced every sub-field, but only once per several sub-fields, resulting in a lower luminance for the black level. In this strategy, however, since the priming effect resulting from the priming discharge is reduced, the write discharge is less prone to occur, leading to a problem of failing to provide a satisfactory image.

The plasma display panel described in Patent Document 3, in turn, has a problem in that the problem of insufficient levels of gradation for displaying a dark image is still left unsolved.

### SUMMARY OF THE INVENTION

The present invention has been proposed to solve the foregoing problems, and it is an object of the invention to provide a plasma display device and a method of driving the same which are capable of ensuring sufficient levels of gradation for displaying a dark image while avoiding an increase in manufacturing cost, and sufficiently reducing the display luminance for the black level to display a satisfactory image.

To solve the aforementioned problems, according to a first aspect of the present invention, a plasma display device comprises a plasma display panel which includes a first substrate and a second substrate disposed opposite to each other, a plurality of surface discharge electrode pairs disposed on a surface of the first substrate opposite to the second substrate, and each composed of a scanning electrode and a discharge sustain electrode disposed in parallel with each other across a discharge gap, a plurality of data electrodes disposed on a surface of the second substrate opposite to the first substrate to intersect with each of the surface discharge electrode pairs, a plurality of unit cells each formed in each of intersecting regions of the plurality of surface discharge electrode pairs with the plurality of data electrodes, and a discharge gas space including each unit cell and formed by filling a discharge gas between the first substrate and the second substrate, wherein the plasma display device divides one frame period of a display screen displayed in gradation by the plurality of unit cells into a plurality of sub-fields weighted based on luminance levels, and sets in each of the sub-field periods a scanning period in which a scanning pulse is sequentially applied to the scanning electrodes and simultaneously a display data pulse synchronized to the scanning pulse is applied to the data electrodes to produce an address discharge in selected ones of the unit cells, a discharge sustain period in which a discharge sustain pulse is alternately applied to the discharge sustain electrodes and the scanning electrodes to drive the unit cells to emit light, a pre-discharge period for producing a sustain erasure discharge for the unit cells which emit light in the discharge sustain period, and a priming discharge for all the unit cells.

In the plasma display device, each of the unit cells comprises a plurality of sub-cells, and a light emission luminance produced by one discharge sustain pulse in one or more of the sub-cells is lower than the light emission luminance of the other sub-cells.

According to a second aspect of the present invention, in the plasma display device according to the first aspect of the present invention, each of the unit cells comprises two sub-cells, one of which is configured such that the light emission luminance per the discharge sustain pulse is lower than the light emission luminance of the other sub-cell.

According to a third aspect of the present invention in the plasma display device according to the first or second aspect of the present invention, each of the sub-cells is arranged to have a different area in a display surface direction of the plasma display panel.

According to a fourth aspect of the present invention, in the plasma display device according to the first or second aspect of the present invention, each of the sub-cells is configured to have a different electrode area of each of the surface discharge electrode pairs opposite to the discharge gas space of the sub-cell.

According to a fifth aspect of the present invention, the plasma display device according to the first or second aspect of the present invention, each of the surface discharge electrode pairs opposing the each sub-cell is made of different material.

According to a sixth aspect of the present invention, the plasma display device according to the first or second aspect of the present invention, a portion of each of the sub-cells of the first substrate corresponding to the discharge gas space has a different light transmissivity.

According to a seventh aspect of the present invention, in the plasma display device according to the first or second aspect of the present invention, and is characterized in that a portion of each of the sub-cells of the second substrate corresponding to the discharge gas space has a different light transmissivity.

According to an eighth aspect of the present invention, in the plasma display device according to any of the first to seventh features of the present invention, two of the discharge gaps between each of the scanning electrodes of each surface discharge electrode pair and two of the discharge sustain electrodes placed on both sides of the scanning electrode cause two of the sub-cells to emit light, respectively.

According to a ninth aspect of the present invention, a driving method for use in plasma display device comprises a plasma display panel which includes a first substrate and a second substrate disposed opposite to each other, a plurality of surface discharge electrode pairs disposed on a surface of the first substrate opposite to the second substrate, and each composed of a scanning electrode and a discharge sustain electrode disposed in parallel with each other across a discharge gap, a plurality of data electrodes disposed on a surface of the second substrate opposite to the first substrate to intersect with each surface discharge electrode pair, a plurality of unit cells each formed in each of intersecting regions of the plurality of surface discharge electrode pairs with the plurality of data electrodes, and a discharge gas space including each unit cell and formed by filling a discharge gas between the first substrate and the second substrate, wherein the plasma display device divides one frame period of a display screen displayed in gradation by the plurality of unit cells into a plurality of sub-fields weighted based on luminance levels, and sets in each of the sub-field periods a scanning period in which a scanning pulse is sequentially applied to the scanning electrodes and simultaneously a display data pulse synchronized to the scanning pulse is applied to the data electrodes to produce an address discharge in selected ones of the unit cells, a discharge sustain period in which a discharge sustain pulse is alternately applied to the discharge sustain electrodes and the scanning electrodes to drive the unit cells to emit light, a pre-discharge period for producing a sustain erasure discharge for the unit cells which emit light in the discharge sustain period, and a priming discharge for all the unit cells. In the method, each of the unit cells are composed of a plurality of sub-cells, and an applied voltage waveform of the discharge sustain pulse is changed from one to another of the sub-cells to set a light emission luminance produced by one discharge sustain pulse in one or more of the sub-cells to be lower than the light emission luminance of the other sub-cells.

According to a tenth aspect of the present invention, a driving method for use in plasma display device comprises a plasma display panel which includes a first substrate and a second substrate disposed opposite to each other, a plurality of surface discharge electrode pairs disposed on a surface of the first substrate opposite to the second substrate, and each composed of a scanning electrode and a discharge sustain electrode disposed in parallel with each other across a discharge gap, a plurality of data electrodes disposed on a surface of the second substrate opposite to the first substrate to intersect with each surface discharge electrode pair, a plurality of unit cells each formed in each of intersecting regions of the plurality of surface discharge electrode pairs with the plurality of data electrodes, and a discharge gas space including each unit cell and formed by filling a discharge gas between the first substrate and the second substrate, wherein the plasma display device divides one frame period of a display screen displayed in gradation by the plurality of unit cells into a plurality of sub-fields weighted based on luminance levels, and sets in each of the sub-field periods a scanning period in which a scanning pulse is sequentially applied to the scanning electrodes and simultaneously a display data pulse synchronized to the scanning pulse is applied to the data electrodes to produce an address discharge in selected ones of the unit cells, a discharge sustain period in which a discharge sustain pulse is alternately applied to the discharge sustain electrodes and the scanning electrodes to drive the unit cells to emit light, a pre-discharge period for producing a sustain erasure discharge for the unit cells which emit light in the discharge sustain period, and a priming discharge for all the unit cells. In the method, each of the unit cells is composed of a plurality of sub-cells, and a sub-cell which is driven to emit light is changed from one to another of the sub-fields to set a light emission luminance produced by one discharge sustain pulse in one or more of the sub-cells to be lower than the light emission luminance of the other sub-cells.

According to an eleventh aspect of the present invention in the driving method according to the tenth aspect of the present invention, each of the unit cells is composed of two sub-cells, two of the discharge gaps between each scanning electrode of each surface discharge electrode pair and two of the discharge sustain electrodes placed on both sides of the scanning electrode cause two of the sub-cells to emit light, respectively, and a sub-cell driven to emit light is changed from one to another of the sub-fields to set a light emission luminance produced by one discharge sustain pulse in one or more of the sub-cells to be lower than the light emission luminance of the other sub-cells.

According to a twelfth aspect of the present invention, in the driving method according to the eleventh aspect of the present invention, a luminance level of the sub-field having the highest luminance assigned to a darker sub-cell of the two sub-cells is set to be lower than a luminance level of the sub-field having the lowest luminance assigned to a brighter sub-cell.

According to a thirteenth aspect of the present invention, in the driving method according to the twelfth aspect of the present invention, the ratio of the luminance level of the sub-field having the lowest luminance assigned to the brighter sub-cell to the luminance level of the sub-field having the highest luminance assigned to the darker sub-cell is approximately 2:1.

According to a fourteenth aspect of the present invention, in the driving method according to any of the ninth to thirteenth aspects of the present invention, the priming discharge in each sub-field is produced in the sub-cell having the lowest light emission luminance produced by one discharge sustain pulse.

According to the configuration of the present invention, each unit cell is composed of a plurality of sub-cells, and a light emission luminance produced by one discharge sustain pulse in one or more of these sub-cells is set to be lower than a light emission luminance of the other sub-cells, so that a darker sub-cell can be made to have a sub-field of a lower level of gradation than the sub-field having the lowest level of gradation of a brighter sub-cell. Also, since the priming discharge in each sub-field is produced in the sub-cell which presents the lowest light emission luminance per discharge sustain pulse, the light emission luminance can be sufficiently reduced when black is displayed, thus making it possible to display a satisfactory image.

The present invention provides a plasma display device and a driving method for use in the plasma display device which can produce sufficient levels of gradation when a dark image is displayed by creating a darker sub-cell which has a sub-field of a lower level of gradation than the sub-field having the lowest level of gradation of a brighter sub-cell, and sufficiently reduce the display luminance for a black level by producing a priming discharge in the darker sub-cell.

### BRIEF DESCRIPTION OF THE DRAWINGS

FIG. 1 is a perspective view showing the configuration of a main portion of a three-electrode surface discharge type PDP;

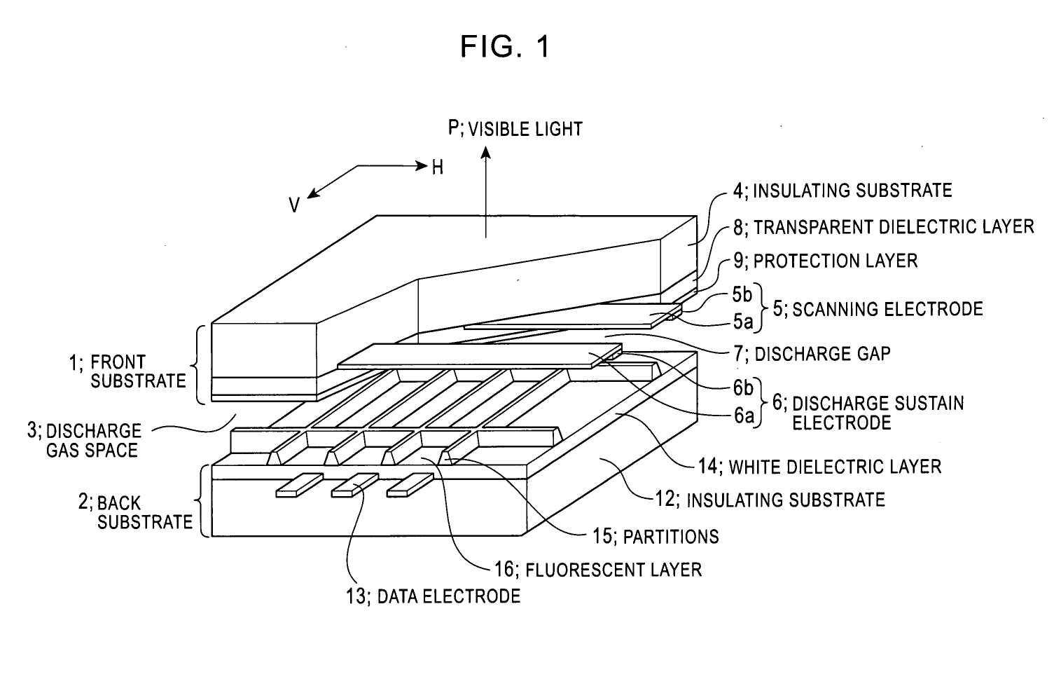

FIG. 2 is a plan view generally showing the configuration of electrodes arranged in the PDP of FIG. 1;

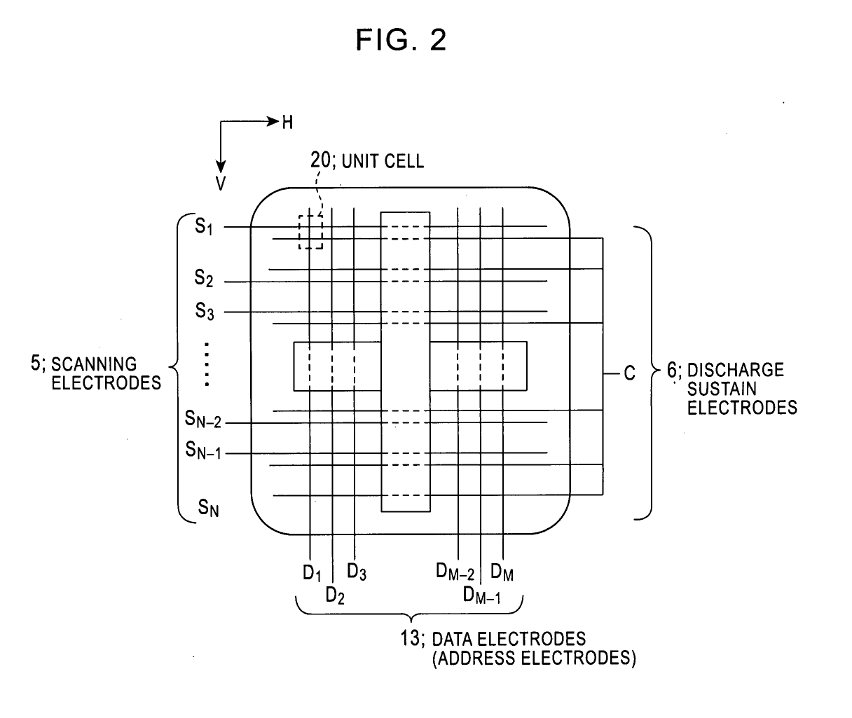

FIG. 3 is a plan view generally showing the configuration of part of the electrodes arranged in the PDP of FIG. 2;

FIG. 4 is a waveform chart for explaining the operation in a sub-field TS;

FIG. 5 is a diagram for explaining the principles of a halftone display method used for the PDP of FIG. 2;

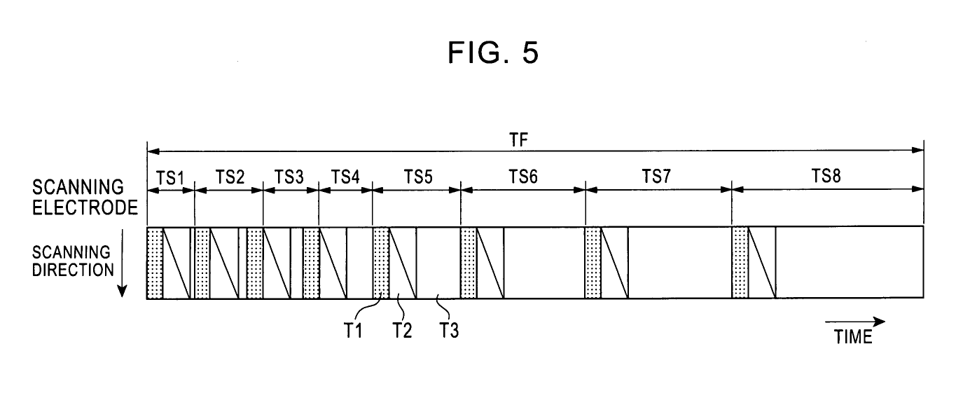

FIG. 6 is a plan view, seen from a display surface side of a PDP which comprises a main portion of a plasma display device in one embodiment of the present invention;

FIG. 7 is a cross-sectional view taken along an A-A line in FIG. 6;

FIG. 8 is a schematic diagram of a main portion in FIG. 1;

FIG. 9 is a block diagram generally showing an exemplary electric configuration of a plasma display device which employs the PDP of FIG. 6;

FIG. 10 is a waveform chart of voltages supplied in a pre-discharge period;

FIG. 11 is a schematic diagram showing the operation in a pre-discharge period shown in FIG. 10;

FIG. 12 is a waveform chart of voltages applied in a scanning period and a discharge sustain period in a sub-field in which a large sub-cell 37 is driven to emit light;

FIG. 13 is a schematic diagram showing the operation of the large sub-cell 37 when it emits light in the scanning period and discharge sustain period shown in FIG. 12;

FIG. 14 is a waveform chart of voltages applied in the scanning period and discharge sustain period in a sub-field in which a small sub-cell 38 is driven to emit light;

FIG. 15 is a schematic diagram showing the operation of the mall sub-cell 38 when it emits light in the scanning period and discharge sustain period shown in FIG. 14;

FIG. 16 is a diagram showing how sub-fields are arranged;

FIGS. 17A to 17D are diagrams each showing another arrangement of the sub-fields; and

FIG. 18 is a plan view seen from a display surface side of another PDP.

### DETAILED DESCRIPTION OF THE INVENTION

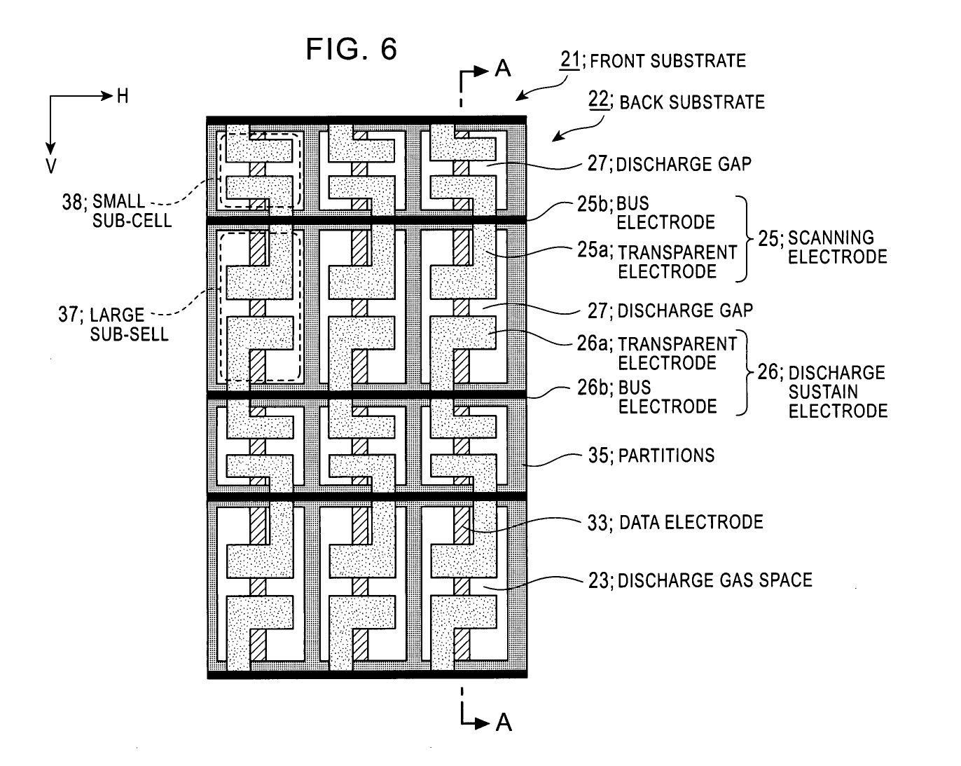

FIG. 6 is a plan view seen from a display surface side of a PDP which comprises a main portion of a plasma display device in one embodiment of the present invention.

The PDP in this embodiment, as shown in FIG. 6, comprises a front substrate 21, a back substrate 22, a discharge gas space 23, scanning electrodes 25, discharge sustain electrodes 26, a discharge gap 27, data electrodes 33, partitions 35, large sub-cells 37, and small sub-cells 38. The front substrate 21 and back substrate 22 are disposed opposite to each other. The scanning electrodes 25 and discharge sustain electrodes 26 are disposed on a surface of the front substrate 21 opposite to the back substrate 22, and face each other across the discharge gap 27 of a predetermined width to make up surface discharge electrode pairs. The scanning electrode 25 is composed of a transparent electrode 25a and a bus electrode 25b. The bus electrode 25b is made of a metal material such as Al (aluminum), Cu (copper), Ag (silver), a multi-layer thin film such as Cr/Cu/Cr, or the like, and is formed to make electrically conductive each transparent electrode 25a which is arranged insularly in a row direction H. The discharge sustain electrode 26 is composed of a transparent electrode 26a and a bus electrode 26b. The bus electrode 26b is made of a metal material similar to the bus electrode 25b, and is formed to make electrically conductive each transparent electrode 26a arranged insularly in the row direction H.

The data electrode 33 is formed of Ag, Al, Cu or the like, and is arranged on a surface of the back substrate 22 opposite to the front substrate to intersect with each of the surface discharge electrode pairs. The partitions 35 are made of lead containing flit glass or the like, and are formed in parallel crosses in the row direction H and column direction V for partitioning individual large sub-cells 37 and small sub-cells 38. The partitions 25 are formed by a printing method, a sand blast method, a transfer method or the like. The scanning electrode 25 and discharge sustain electrode 26 are formed to straddle over the partitions 35, and the large sub-cells 37 and small sub-cells 38 are formed at respective intersecting regions of a plurality of surface discharge electrode pairs (scanning electrodes 25 and discharge sustain electrodes 26) with a plurality of data electrodes 38. One unit cell is made up of a combination of the large sub-cell 37 and small sub-cell 38 surrounded by the partitions 35.

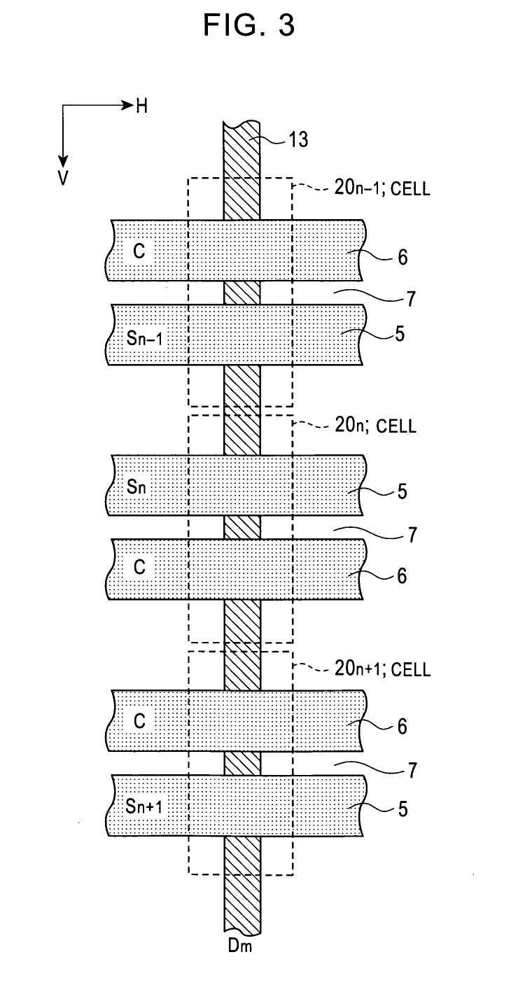

In the prior art example shown in FIG. 3, the discharge gap 7 is formed only on one side of each of the scanning electrode 5 and discharge sustain electrode 6, whereas in this embodiment, two discharge gaps 27 are formed between the scanning electrode 25 and the two discharge sustain electrodes 26 arranged on both sides of the scanning electrode 25. Consequently, the number of the discharge gaps 27 is twice as much as that of the conventional discharge gaps 7, and the number of the cells is correspondingly increased by a factor of two. These discharge gaps 27 cause the large sub-cell 37 and small sub-cell 38 to emit light, respectively. The sizes of the large sub-cell 37 and small sub-cell 38 corresponding to each discharge gap 27 (area surrounded by the partitions 35) alternately differ in the column direction V. The discharge gas space 23 includes each of the unit cells, and is formed by filling a discharge gas between the front substrate 21 and the back substrate 22.

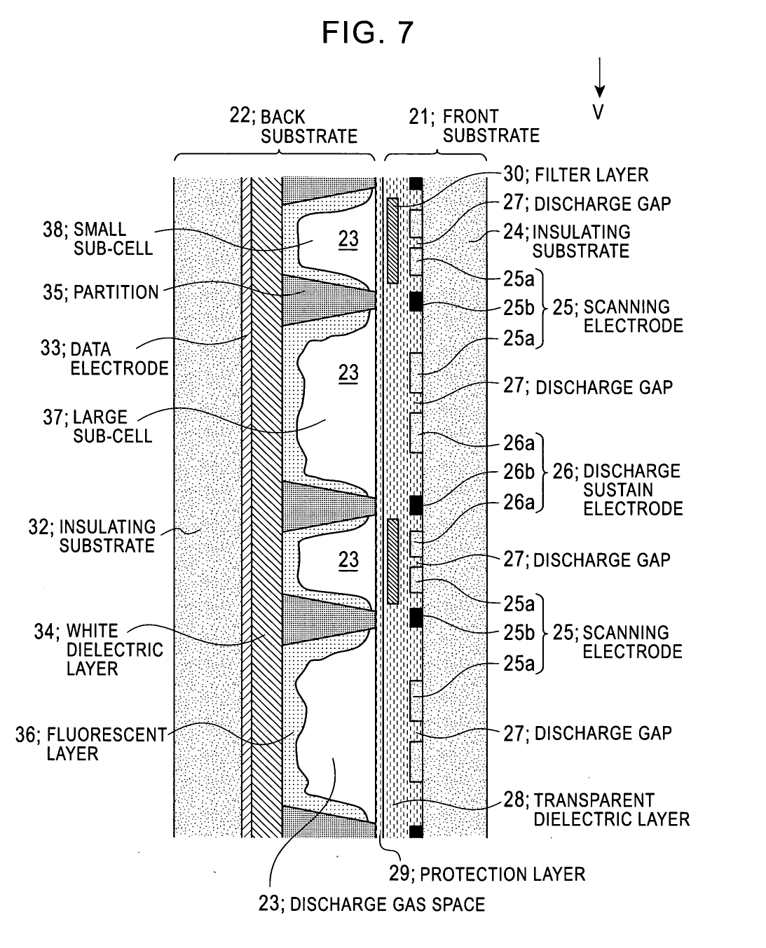

FIG. 7 is a cross-sectional view taken along an A-A line of the PDP in FIG. 6.

As shown in FIG. 7, the front substrate 21 is provided with an insulating substrate 24, a transparent dielectric layer 28, a protection layer 29, and a filter layer 30 in addition to the scanning electrodes 25 and discharge sustain electrodes 26 in FIG. 6. The insulating substrate 25 is made of a transparent material, for example, soda lime glass or the like, and is formed in a thickness of approximately 1 to 5 mm. The scanning electrodes 25 and discharge sustain electrodes 26 are made of ITO (Indium Thin Oxide), tin oxide (SnO2) or the like, and is formed on the insulating substrate 24 in a thickness of approximately 100 to 500 nm. The transparent dielectric layer 28 is made, for example, of low-melting point lead glass or the like, and formed in a thickness of approximately 5 to 80 μm to cover the scanning electrodes 25 and discharge sustain electrodes 26. The transparent dielectric layer 28 is formed by coating a low-melting point lead glass paste or the like to cover the row electrodes, and baking the paste at temperatures equal to or higher than the softening point of the paste. The protection layer 29 is made, for example, of MgO (magnesium oxide) or the like, and is formed in a thickness of approximately 0.5 to 2.0 μm to protect the transparent dielectric layer 28 from discharges. The protection layer 29 is formed by a sputtering method, a vapor deposition method or the like. The filter layer 30 is formed in regions corresponding to the small sub-cells 38 in the transparent dielectric layer 38 to reduce the light transmissivity from the small sub-cells 38.

The back substrate 22 is also provided with an insulating substrate 32, a white dielectric layer 34, and a fluorescent layer 37, in addition to the data electrodes 33 and partitions 35 in FIG. 6. The insulating substrate 32 is made, for example, of soda lime glass or the like, and is formed in a thickness of approximately 2 to 5 mm. The white dielectric layer 34 is formed, for example, by coating a low-melting point lead glass paste mixed with a white pigment such as titanium oxide powder, alumina powder or the like to cover the data electrodes 33, and then baking the paste. After the baking, the white dielectric layer 34 has a thickness of approximately 5 to 40 μm. The fluorescent layer 36 is coated on the wall surface of each cell and the white dielectric layer 34 to convert ultraviolet rays generated by a discharge of the discharge gas into visible light. These fluorescent layers 36 are painted on a cell-by-cell basis using respective fluorescent materials for emitting light in the three primary colors of light, i.e., red (R), green (G), and blue (B). With these painted cells, a color display PDP can be provided.

The front substrate 21 and back substrate 22 are adhered to each other with a sealing material such as lead glass flit for fixation in a mutually opposing state, and then are baked at temperatures of 300 to 500° C. for adhesion. Subsequently, the discharge gas space 23 is exhausted, filed with a simple discharge gas such as He, N3, Ar, Kr, Xw, N₂, O₂, CO₂ or the like or a mixture gas at approximately 200 to 700 Torr, and hermetically sealed to complete the PDP.

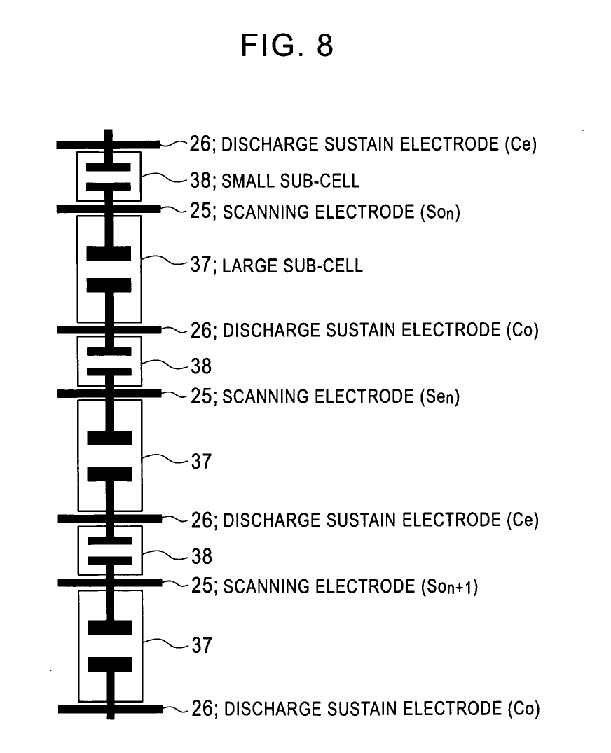

FIG. 8 is a schematic diagram of a main portion in FIG. 6.

As shown in FIG. 8, the areas of the scanning electrode 25 and discharge sustain electrode 26 opposing the discharge gas space 23 in FIG. 6 are different in the large sub-cell 37 and small sub-cell 38. In this way, for one cycle of a discharge sustain pulse alternately applied to the discharge sustain electrode 26 and scanning electrode 25, the light emission luminance of the small sub-cell 38 is lower than the light emission luminance of the large sub-cell 37. In this embodiment, the ratio of the light emission luminance of the large sub-cell 37 to the small sub-cell 38 is set to 10:1, by way of example.

Also, the scanning electrodes 25 and discharge sustain electrodes 26 belong to different groups for even-numbered rows and odd-numbered rows, where the scanning electrode 25 on an odd-numbered row is designated by a scanning electrode So; the scanning electrode 25 on an even-numbered row by scanning electrode Se; the discharge sustain electrode 26 on an odd-numbered row by a discharge sustain electrode Co, and the discharge sustain electrode 26 on an even-numbered row by a discharge sustain electrode Ce.

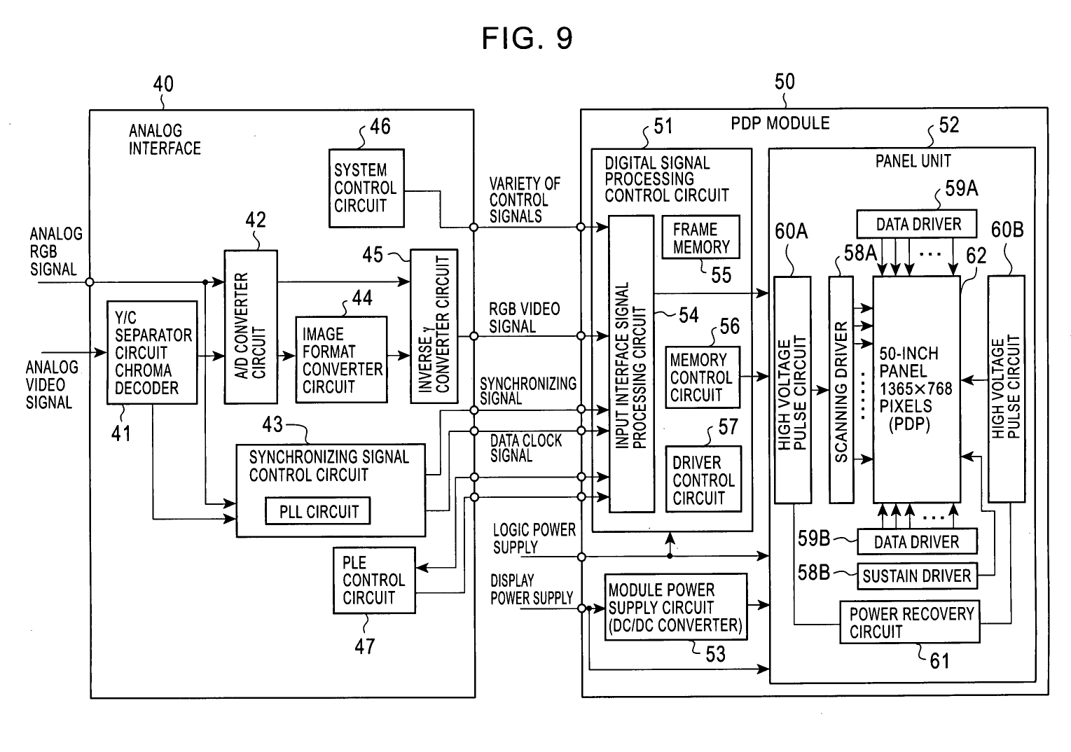

FIG. 9 is a general block diagram showing an exemplary electric configuration of a plasma display device which employs the PDP of FIG. 6.

This plasma display device comprises an analog interface 40 and a PDP module 50. The analog interface 40 comprises a Y/C (luminance/color) separator circuit 41 including a chroma decoder; an A/D (analog-to-digital) converter circuit 42; a synchronizing signal control circuit 43 having a PLL (phase locked loop) circuit; an image format converter circuit 44; an inverse y converter circuit 45; a system control circuit 46; and a PLE (Peak Luminance Enhancement) control circuit 47. The PDP module 50 comprises a digital signal processing control circuit 51; a panel unit 52; and a module power supply circuit 53 which contains a DC/DC converter. The digital signal processing control circuit 51 comprises an input interface signal processing circuit 54, a frame memory 55, a memory control circuit 56, and a driver control circuit 57.

The panel unit 52 comprises a PDP 62; a scanning driver 58A for driving the scanning electrodes of the PDP 62; a sustain driver 58B for driving the discharge sustain electrodes of the PDP 62; data drivers 59A, 59B for driving the data electrodes; high voltage pulse circuits 60A, 60B for supplying pulse voltages to the PDP 62 and scanning driver 58; and a power recovery circuit 61 for recovering surplus power generated in the high voltage pulse circuits 60A, 60B.

Generally speaking, in this plasma display device, an analog video signal corresponding to the interlace is converted to a digital video signal by the analog interface 40, and the digital video signal is supplied to the PDP module 50. For example, an analog video signal output from a television tuner, not shown, is separated into luminance signals of R, G, B colors by the Y/C separator circuit 41, and then the respective luminance signals are converted to digital video signals by the A/D converter 42.

Also, while the characteristic of a display luminance of the PDP 62 is linearly proportional to an input signal, a normal video signal has been corrected (γ conversion) in accordance with the characteristic of the CRT. Therefore, after the A/D conversion of an analog video signal made in the A/D converter circuit 42, an inverse γ conversion is performed in the inverse γ converter circuit 45. This inverse γ conversion generates a digital video signals which have been restored to have the linear characteristic. These digital video signals are output to the PDP module 50 as R, G, B video signals.

Also, since an analog video signal does not include a sampling clock for A/D conversion or a data clock signal, the PLL circuit contained in the synchronizing signal control circuit 43 generates a sampling signal and a data clock signal with reference to a horizontal synchronizing signal supplied simultaneously with the analog video signal, and outputs the sampling signal and data clock signal to the PDP module 50. The PLE control circuit 47 of the analog interface 40 controls the luminance for the PDP module 50. Specifically, the display luminance is increased when an average luminance level is equal to or lower than a predetermined value, while the display luminance is reduced when the average luminance level exceeds the predetermined value. The PLE control circuit 47 sets luminance control data in accordance with the average luminance level, and sends the luminance control data to a luminance level control circuit, not shown, in the input interface signal processing circuit 54.

A variety of control signals are sent from the system control circuit 46 to the PDP module 50. For example, an average luminance level of the R, G, B video signals input to the input interface signal processing circuit 54 is calculated by an input signal average luminance level calculator circuit, not shown, in the input interface signal processing circuit 54, and is output, for example, as 10-bit data. In the digital signal processing control circuit 51, after a variety of these signals have been processed by the input interface signal processing circuit 54, a control signal is sent to the panel unit 52. Simultaneously, a memory control signal and a driver control signal are sent to the panel unit 52 from the memory control circuit 56 and driver control circuit 57, respectively.

The PDP 62 has, for example, 1365×768 pixels (unit cells), and is configured as shown in FIG. 6. In the PDP 62, the scanning electrodes are driven by the scanning driver 58A, the discharge sustain electrodes are driven by the sustain driver 58B, and the data electrodes are driven by the data drivers 59A, 59B, thereby controlling predetermined pixels (unit cells) in these pixels (unit cells) to emit light or not for displaying an image corresponding to R, G, B video signals. In this event, one frame period of the display screen is divided into a plurality of weighted sub-fields by the driver control circuit 57 based on luminance levels, and a scanning period, a discharge sustain period, and a pre-discharge period are set in each of the sub-fields.

In the scanning period, a scanning pulse is sequentially applied to the respective scanning electrodes, and a display data pulse synchronized with the scanning pulse is simultaneously applied to the respective data electrodes, thus producing an address discharge in selected unit cells. In the pre-discharge period, a sustain erasure discharge is produced for those unit cells which emit light in the discharge sustain period, and a priming discharge is produced for all unit cells. Also, logic power is supplied to the digital signal processing control circuit 51 and panel unit 52 by a logic power supply. Also, the module power supply circuit 53 is supplied with DC power from a display power supply, and the voltage of this DC power is converted to a predetermined voltage which is then supplied to the panel unit 52.

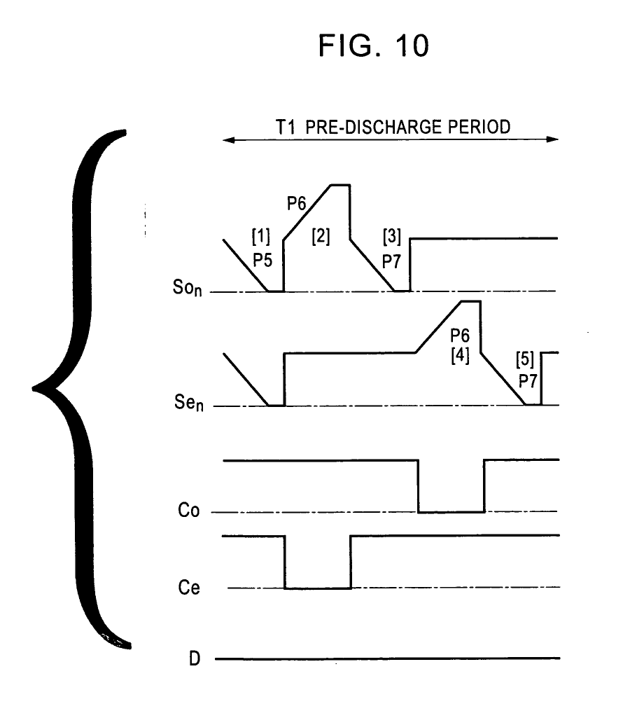

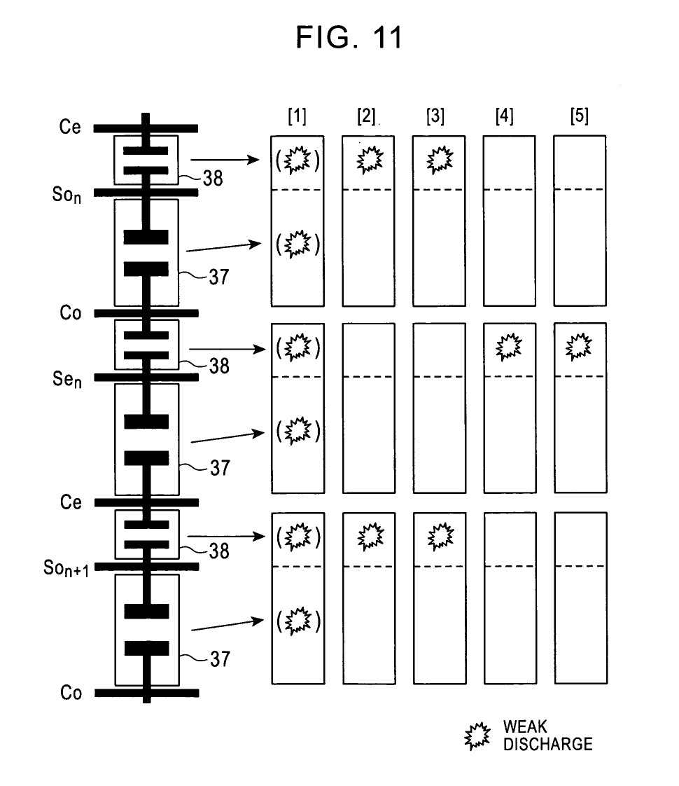

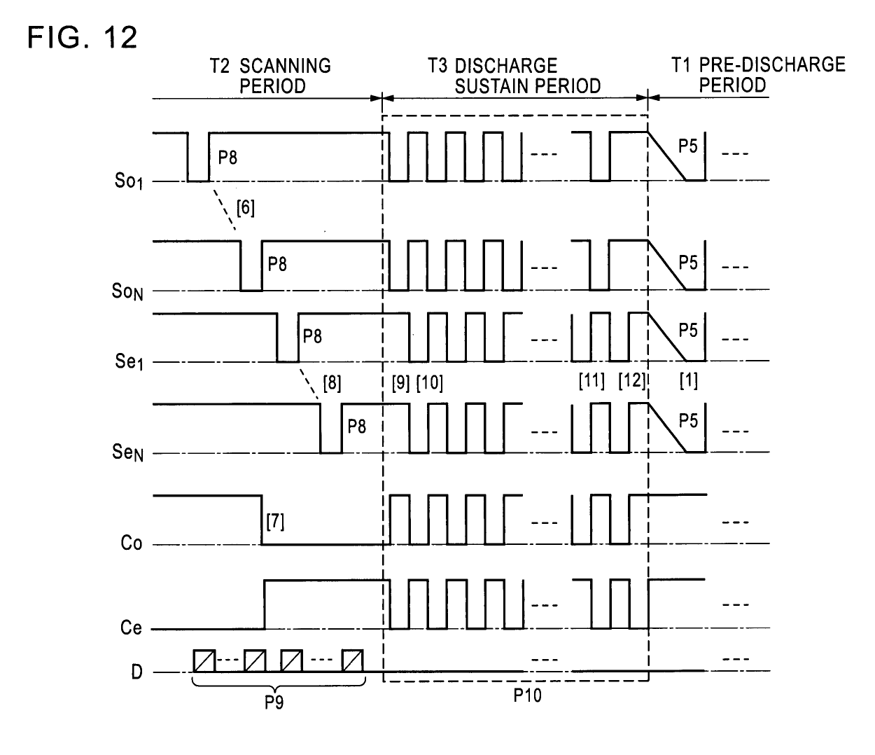

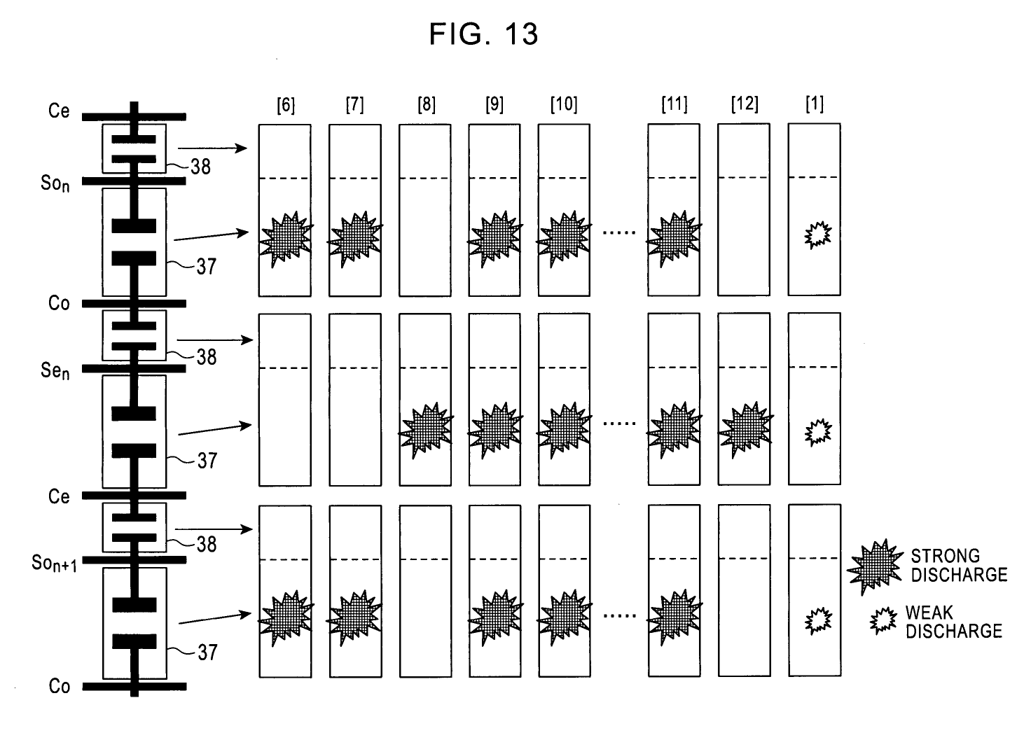

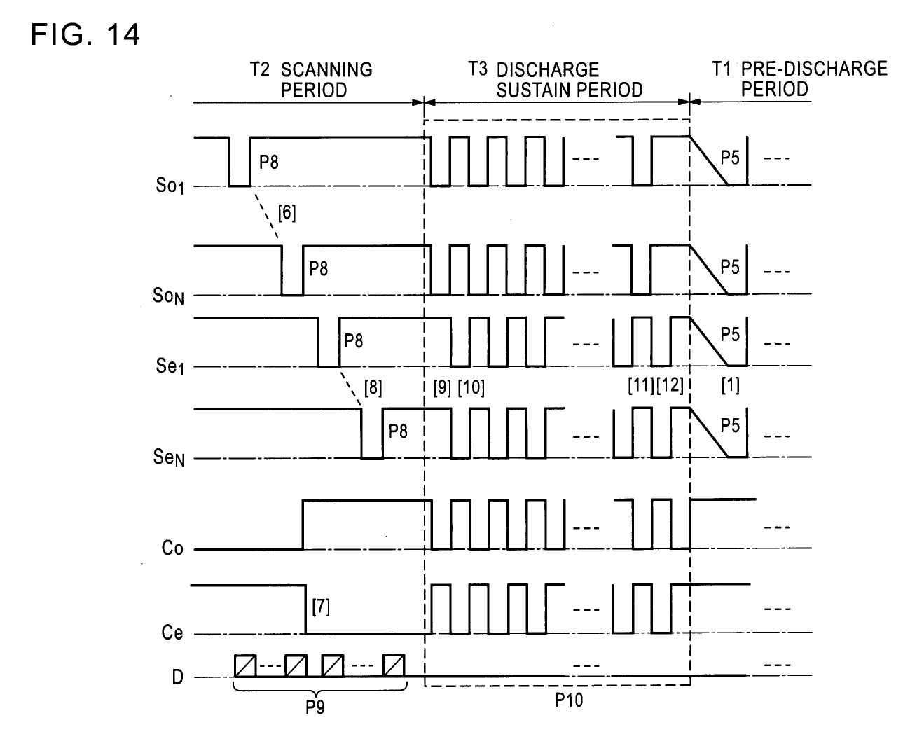

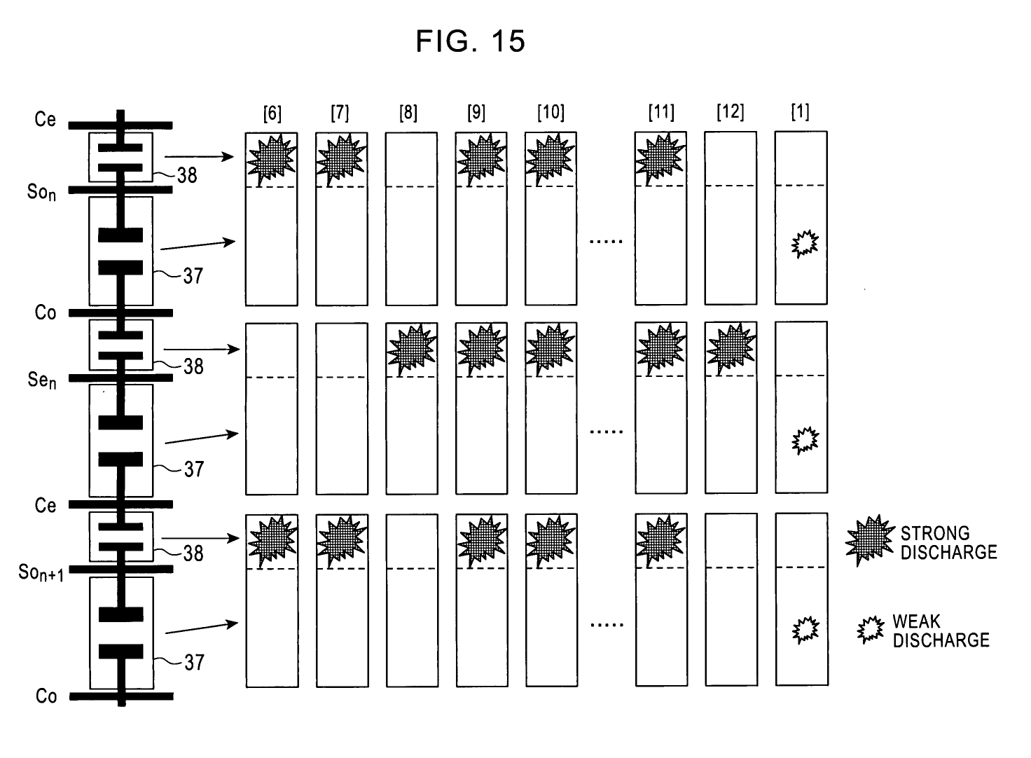

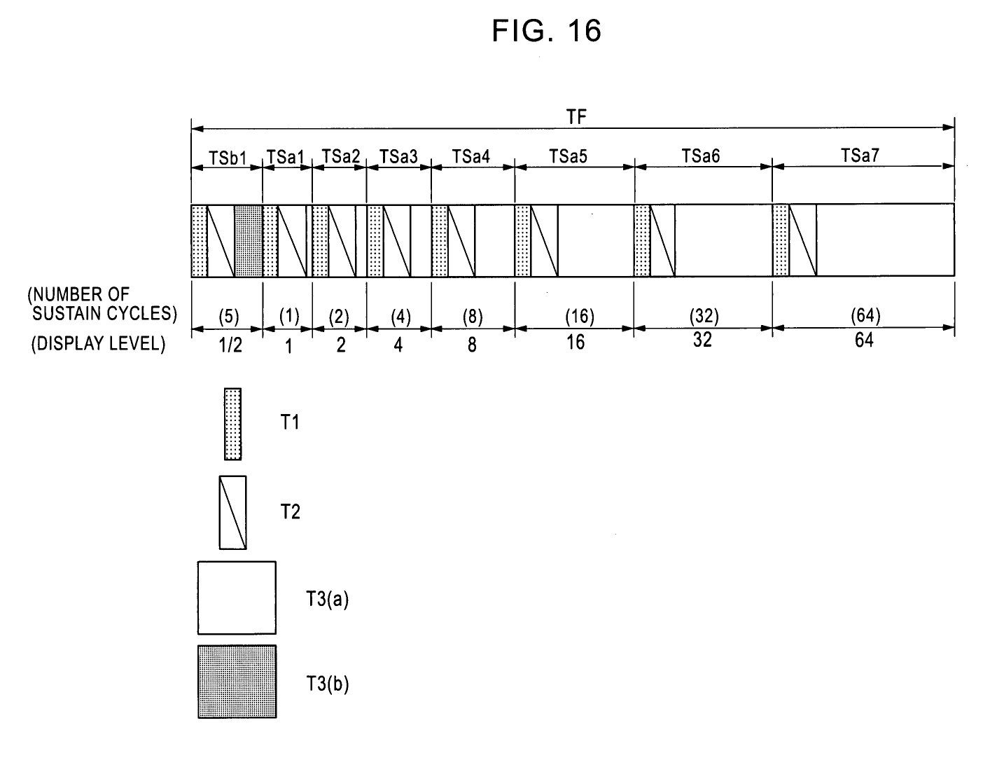

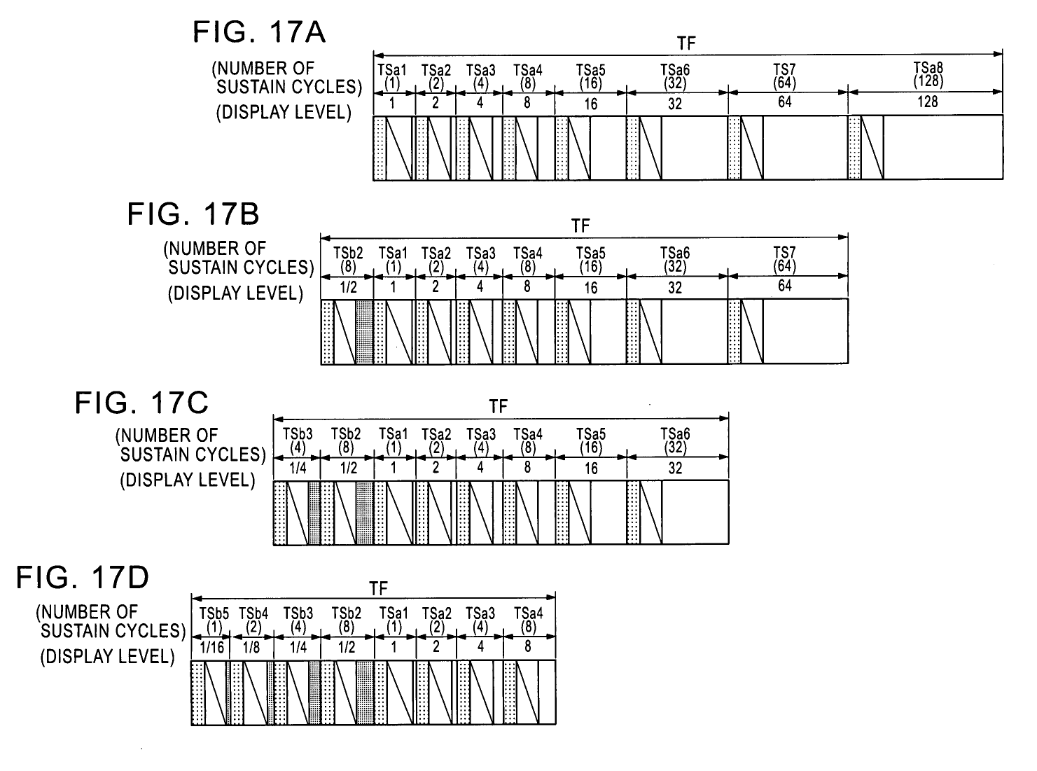

FIG. 10 is a waveform chart of voltages applied in the pre-discharge period, FIG. 11 is a schematic diagram showing the operation in the pre-discharge period shown in FIG. 10, FIG. 12 is a waveform chart of voltages applied in the scanning period and discharge sustain period in a sub-field in which the large sub-cell 37 is driven to emit light, FIG. 13 is a schematic diagram showing the operation of the large sub-cell 37 when it emits light in the scanning period and discharge sustain period shown in FIG. 12, FIG. 14 is a waveform chart of voltages applied in the scanning period and discharge sustain period in a sub-field in which the small sub-cell 38 is driven to emit light, FIG. 15 is a schematic diagram showing the operation of the small sub-cell 38 when it emits light in the scanning period and discharge sustain period shown in FIG. 14, FIG. 16 is a diagram showing how the sub-fields are arranged, and FIGS. 17A to 17D are diagrams showing other arrangements of the sub-fields.

The contents of processing in a driving method used in this exemplary plasma display device will be described with reference to these figures.

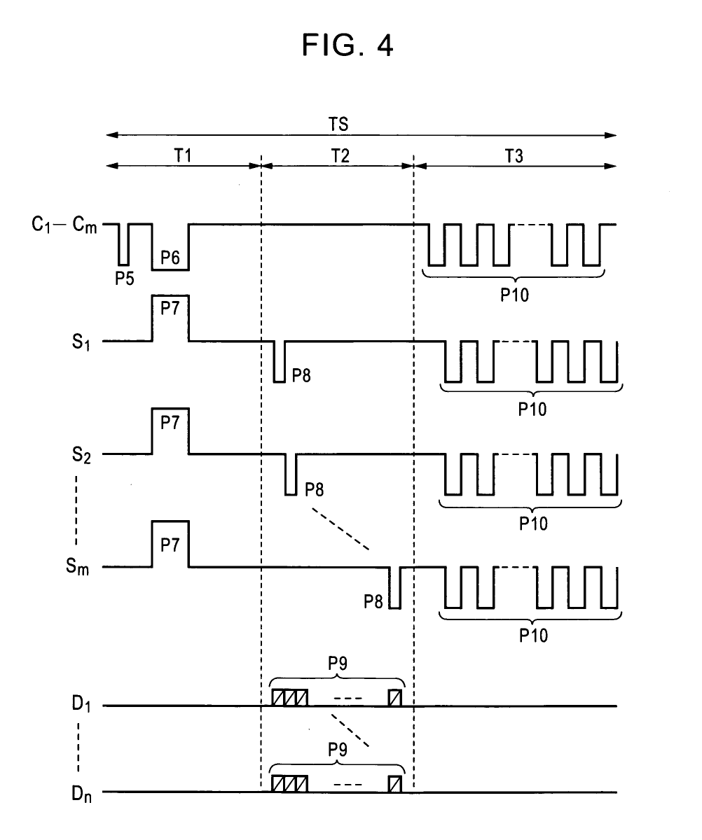

In this method of driving the plasma display device, one field TF is divided into a plurality of sub-fields TS as before, and a pre-discharge period T1 shown in FIG. 10, and a scanning period T2 and a discharge sustain period T3 shown in FIG. 12 or 14 are set in one sub-field TS. Also, scanning electrodes So₁, So₂, . . . , So_{N} on odd-numbered rows, and scanning electrodes Se₁, Se₂, . . . , Se_{N} on even-numbered rows are arranged in sequence. Therefore, the total number of scanning electrodes amounts to 2N, and the number of unit cells also amounts to 2N. Also, in this embodiment, voltages applied to the scanning electrodes and discharge sustain electrodes on the odd-numbered rows have waveforms different from those of voltages applied to the scanning electrodes and discharge sustain electrodes on the even-numbered rows. This embodiment differs in this aspect from the prior art in FIG. 4 in which the voltages having the same waveforms are applied to all the rows other than the scanning pulse P8.

In the pre-discharge period T1, as shown in FIG. 10, a sustain erasure pulse P5 is applied to all cells which have emitted light in the preceding sub-field at timing [1] to produce a sustain erasure discharge for erasing wall charges formed by the sustain discharge, as shown in FIG. 11. The parenthesis in FIG. 11 indicates that the discharge is produced only in cells which have emitted light. At timing [2] in FIG. 10, a priming pulse P6 is applied only to the small sub-cells 38 on the odd-numbered rows to produce a priming discharge shown in FIG. 11. At timing [3] in FIG. 10, an erasure pulse P7 is applied to produce an erasure discharge shown in FIG. 11. At timing [4] in FIG. 10, the priming pulse P6 is applied to the small sub-cells 38 on the even-numbered rows to produce a priming discharge shown in FIG. 11. At timing [5] in FIG. 10, the erasure pulse P7 is applied to produce an erasure discharge shown in FIG. 11.

In this way, the priming discharges (at timings [2], [4]) are produced only in the small sub-cells 38. In this even, the light emission luminance of the small sub-cells 38 per discharge sustain pulse is the lowest, i.e., one tenth as low as the light emission luminance of the large sub-cells 37, so that weak discharges are produced at timings [1]-[5] in the pre-discharge period T1. Therefore, the light emission luminance of the small sub-cells 38 produced by the priming discharge is also one tenth as low as the light emission luminance of the large sub-cells 37. Consequently, the light emission luminance resulting from the priming discharge is reduced to one tenth as low as the prior art, thereby reducing the luminance when black is displayed and providing a display without black floating.

In the large sub-cells 37, in the scanning period T2, a scanning pulse PB is sequentially applied to the scanning electrodes So on the odd-numbered rows at timing [6] as shown in FIG. 12, and a display data pulse P9 is applied to the data electrodes D in synchronism with the scanning pulse P8, causing a strong discharge to write data as shown in FIG. 13. At timing [6] in FIG. 13, while the writing appears to be performed simultaneously into the large sub-cells 37 corresponding to the scanning electrode Soₙ and scanning electrode Soₙ₊₁, the scanning pulse P8 is sequentially applied, so that the writing is not simultaneously performed. Also, in this event, the discharge sustain electrodes Ce on the even-numbered rows are applied with such a voltage (for example, zero volt) that avoids the writing in the small sub-cells 38.

Next, at timing [7], a sustain discharge is once produced only in the large sub-cells 37 in which the writing has been performed, and at subsequent timing [8], the scanning pulse P8 is sequentially applied to the scanning electrodes Se on the even-numbered lines, and a display data pulse P9 is applied to the data electrodes D in synchronism with the scanning pulse P8, to produce a strong discharge to write data thereinto, as shown in FIG. 13. Timings [9] to [12] are included in the discharge sustain period T3 with strong discharges. In this discharge sustain period T3, since the two electrodes (scanning electrode So and discharge sustain electrode Ce, and scanning electrode Se and discharge sustain electrode Co) of the small sub-cell 38 are applied with the same voltage, no discharge is produced in the small sub-cell 38.

At timing [1] in the subsequent pre-discharge period T1, the sustain erasure pulse P5 is applied to cells which have emitted light, to produce a sustain erasure discharge with a weak discharge, as shown in FIG. 8.

In the small sub-cells 38, in the scanning period T2, the scanning pulse P8 is sequentially applied to the scanning electrodes So on the odd-numbered rows at timing [6], and the display data pulse P9 is applied to the data electrodes D in synchronism with the scanning pulse P8, as shown in FIG. 14, to produce a strong discharge to write data into the small sub-cells 38, as shown in FIG. 15. At timing [6] in FIG. 15, while the writing appears to be performed simultaneously in the small sub-cells 38 corresponding to the scanning electrode Soₙ and scanning electrode Soₙ₊₁, the scanning pulse P8 is sequentially applied, so that the writing is not simultaneously performed. In this event, the discharge sustain electrodes Co on the odd-numbered rows are applied with such a voltage (for example, zero volt) that avoids the writing in the large sub-cells 37.

Next, at timing [7], a sustain discharge is once produced only in the small sub-cells 38 in which the writing has been performed, and at subsequent timing [8], the scanning pulse P8 is sequentially applied to the scanning electrodes Se on the even-numbered lines, and a display data pulse P9 is applied to the data electrodes D in synchronism with the scanning pulse P8, to produce a strong discharge to write data thereinto, as shown in FIG. 15. Timings [9] to [12] are included in the discharge sustain period T3 with strong discharges. In this discharge sustain period T3, since the two electrodes (scanning electrode So and discharge sustain electrode Co, and scanning electrode Se and discharge sustain electrode Ce) of the large sub-cell 37 are applied with the same voltage, no discharge is produced in the large sub-cell 37. At timing [1] in the subsequent pre-discharge period T1, the sustain erasure pulse P5 is applied to those cells which have emitted light, as shown in FIG. 14, to produce a sustain erasure discharge with a weak discharge, as shown in FIG. 15.

In this embodiment, a sub-field shown in FIG. 12 for driving the large sub-cells 37 to emit light is designated by TSa, while a sub-field shown in FIG. 14 for driving the small sub-cells 38 to emit light is designated by TSb, and a halftone display is performed by a combination of the sub-fields TSa, TSb. For example, as shown in FIG. 16, a sub-field TSb1 and sub-fields TSa1, TSa2, . . . , TSa7 are set in one field TF. Also, the pre-discharge period T1, scanning period T2, and discharge sustain period T3(b) are set in the sub-field TSb, while the pre-discharge period T1, scanning period T2, and discharge sustain period T3(a) are set in the sub-field TSa. Since the number of cycles of the sustain discharge corresponding to these sub-fields Tsa1, TSa2, . . . , TSa7 are set to 1, 2, 3, 8, 16, 32, 64, the display levels (gradation levels) are set at 1:2:4:8:16:32:64. Thus, 128 levels of gradation can be displayed only with seven sub-fields TSa.

On the other hand, the number of cycles of the sustain discharge corresponding to the sub-field TSb1 is set to 5, but since the light emission luminance per cycle of the sustain discharge of the small sub-cell 38 is one tenth as high as the large sub-cell 37, the display level (gradation) is set to ½ (i.e., TSa1:TSb1=2:1) with the five cycles. Therefore, the gradation levels set by the sub-fields TSb1, TSa1, TSa2, . . . , TSa7 are in the ratio of ½:1:2:4:8:16:32:64, and an image can be displayed at 256 levels of gradation by a combination of these gradation levels. In this way, different sub-cells emit light from one sub-field to another, and the light emission luminance per discharge sustain pulse in the small sub-cell 38 represents one-half level of gradation, which is smaller than the light emission luminance of the large sub-cell 37, so that an image is displayed with smooth gradient even on a dark screen, unlike the prior art which can represent only one or more levels of gradation.

Also, in the driving method of this embodiment, a halftone display may be performed by a combination of the sub-fields TSa, TSb shown in FIGS. 17A to 17D. Specifically, as shown in FIG. 17A, sub-fields TSa1, TSa2, . . . , TSa8 are set in one field TF. Since the number of cycles of the sustain discharge corresponding to these sub-fields TSa1, TSa2, . . . , TSa8 are set to 1, 2, 4, 8, 16, 32, 64, 128, the display levels (gradation levels) are also set to 1:2:4:8:16:32:64:128. Thus, 256 levels of gradation is displayed with eight sub-fields TSa.

As shown in FIG. 17B, the sub-field TSb2 and sub-fields TSa1, TSa2, . . . , TSa7 are set in one field TF. In this driving method, the light emission luminance per one sustain discharge of the small sub-cell 38 is set to 1/16 as high as the light emission luminance of the large sub-cell 37, and the display level (gradation) of the sub-field TSb2 is set to ½ (i.e., TSa1:TSb2=2:1) with eight cycles. Therefore, the gradation levels set by the sub-fields TSb2, TSa1, TSa2, . . . , TSa7 are ½:1:2:4:8:16:32:64, and an image is displayed at 256 levels of gradation by a combination of these gradation levels.

Also, as shown in FIG. 17C, the sub-fields TSb3, TSb2 and sub-fields TSa1, TSa2, . . . , TSa6 are set in one field TF. The display level (gradation) of the sub-field TSb3 is set to ¼ with four cycles. Therefore, the gradation levels set by the sub-fields TSb3, TSb2, TSa1, TSa2, TSa6 are ¼:½:1:2:4:8:16:32, and an image is displayed at 256 levels of gradation by a combination of these gradation levels.

Also, as shown in FIG. 17D, the sub-fields TSb5, TSb4, TSb3, TSb2 and sub-fields TSa1, TSa2, TSa3, TSa4 are set in one field TF. The display level (gradation) of the sub-field TSb5 is set to 1/16 with one cycle, while the display level (gradation level) of the sub-field TSb4 is set to ⅛ with two cycles. Therefore, the gradation levels set by the sub-fields TSb5, TSb4, TSb3, TSb2, TSa1, TSa2, TSa3, TSa4 are 1/16:⅛:¼:½:1:2:4:8, and an image is displayed at 256 levels of gradation by a combination of these gradation levels.

In this way, eight sub-fields are dynamically selected from a total of 12 sub-fields, i.e., the foregoing sub-fields TSb5, TSb4, TSb3, TSb2, TSa1, TSa2, TSa3, TSa4, TSa5, TSa6 in accordance with the brightness of an image to make up one field TF, whereby an image is displayed at 256 levels of gradation. For example, for smoothly displaying the gradation of a dark image, the combination as shown in FIG. 17D is selected. For clearly displaying the gradation of an image which has a high light emission luminance, the combination shown in FIG. 17A is selected.

As described above, in this embodiment, the unit cell is composed of the large sub-cell 37 and small sub-cell 38, and the gradation level of the small sub-cell 38 is set to 1/16, ⅛, ¼, ½ from one sub-field to another, thus smoothly displaying the gradation of a dark image. Also, since the light emission luminance is sufficiently reduced when black is displayed by the priming discharge produced in the small sub-cell 38, a satisfactory image is displayed.

While one embodiment of the present invention has been described in detail with reference to the drawings, the specific configuration is not limited to the foregoing embodiment, but any change in design without departing from the spirit and scope of the invention should be included in the present invention.

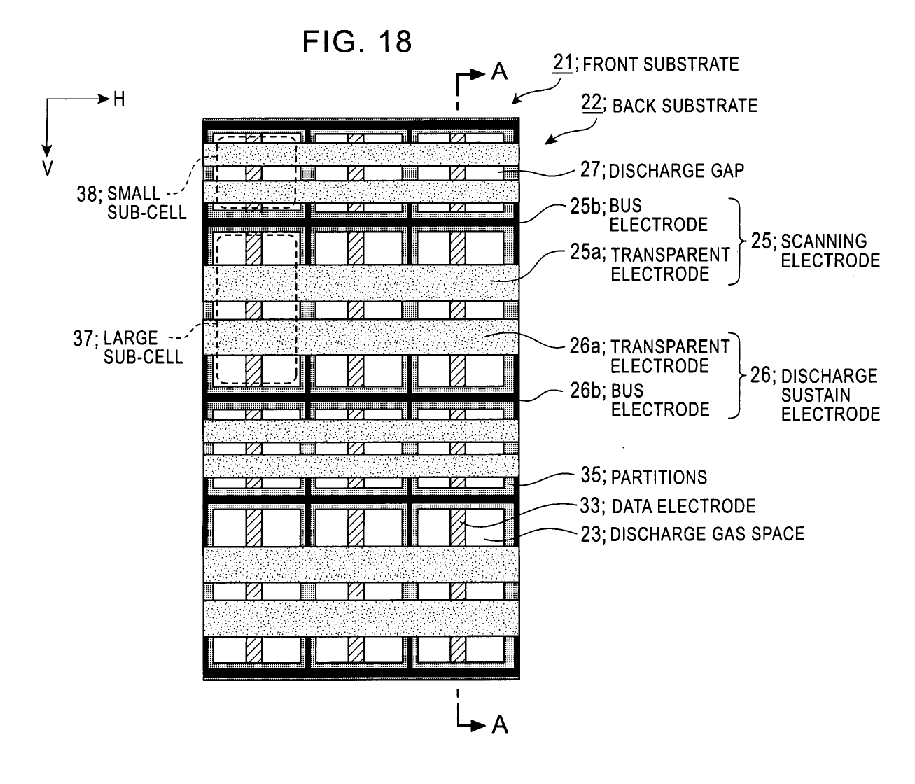

For example, as shown in FIG. 18, the scanning electrodes 25, discharge sustain electrodes 36, and partitions 35 may be in different shapes as long as the PDP shown in FIG. 6 comprises the large sub-cells 37 and small sub-cells 38. A cross-sectional view taken along an A-A line of FIG. 18 is similar to FIG. 7. Also, while the filter layer 30 in FIG. 7 is formed in the transparent dielectric layer 28, the filter layer 30 may be formed at an arbitrary location as long as it can reduce the transmissivity of light from the small sub-cell 38. Also, at timing [6] in FIG. 12, a voltage of zero volt is applied to the discharge sustain electrode Ce, but another voltage may be applied, provided that the voltage does not cause the writing in the small sub-cell 38. Also, at timing [6] in FIG. 15, a voltage of zero volt is applied to the discharge sustain electrode Co, but another voltage may be applied, provided that the voltage does not cause the writing in the large sub-cell 37.

A method of driving the large sub-cell 37 and small sub-cell 38 to emit light at different luminances may involve forming the scanning electrodes and discharge sustain electrodes corresponding to the small sub-cells 37 of a metal material to shield the light emitted through a discharge, making the back substrate 22 to have different light reflectivities for the large sub-cells 37 and small sub-cells 38, reducing a voltage applied to the small sub-cells 37 when they are driven to emit light, changing the pulse waveforms of the voltages applied to the large sub-cells 37 and small sub-cells 38 (for example, varying the frequency or pulse width). Also, in FIG. 16 and FIGS. 17A to 17D, the ratio of the light emission luminance of the large sub-cells 37 to the light emission luminance of the small sub-cells 38, and the luminance level in each sub-field are not limited to the values shown in the figures, as long as necessary levels of gradation can be displayed. Further, while either the large sub-cells 37 or the small sub-cells 38 emit light in each sub-field in FIG. 16 or FIGS. 17A to 17D, a sub-field may be set to drive a combination of both the large sub-cells 37 and small sub-cells 38 to emit light.

The present invention can be applied to plasma display devices in general which need to smoothly display the gradation of a dark image.

This application is based on Japanese Patent application No. 2004-113691 which is hereby incorporated by reference.

1. A plasma display device comprising a plasma display panel which includes:
a first substrate and a second substrate disposed opposite to each other;
a plurality of surface discharge electrode pairs disposed on a surface of said first substrate opposite to said second substrate, and each composed of a scanning electrode and a discharge sustain electrode disposed in parallel with each other across a discharge gap;
a plurality of data electrodes disposed on a surface of said second substrate opposite to said first substrate to intersect with said each surface discharge electrode pair;
a plurality of unit cells each formed in each of intersecting regions of said plurality of surface discharge electrode pairs with said plurality of data electrodes; and
a discharge gas space including said each unit cell and formed by filling a discharge gas between said first substrate and said second substrate,
wherein said plasma display device divides one frame period of a display screen displayed in gradation by said plurality of unit cells into a plurality of sub-fields weighted based on luminance levels, and sets in each of said sub-field periods a scanning period in which a scanning pulse is sequentially applied to said scanning electrodes and simultaneously a display data pulse synchronized to the scanning pulse is applied to said data electrodes to produce an address discharge in selected ones of said unit cells, a discharge sustain period in which a discharge sustain pulse is alternately applied to said discharge sustain electrodes and said scanning electrodes to drive said unit cells to emit light, a pre-discharge period for producing a sustain erasure discharge for said unit cells which emit light in the discharge sustain period, and a priming discharge for all said unit cells,
wherein each of said unit cells comprises a plurality of sub-cells, and a light emission luminance produced by one discharge sustain pulse in one or more of said sub-cells is lower than the light emission luminance of the other sub-cells.

2. A plasma display device according to claim 1, wherein said each unit cell comprises two sub-cells, one of which is configured such that the light emission luminance per the discharge sustain pulse is lower than the light emission luminance of the other sub-cell.

3. A plasma display device according to claim 1, wherein said each sub-cell is arranged to have a different area in a display surface direction of said plasma display panel.

4. A plasma display device according to claim 2, wherein said each sub-cell is arranged to have a different area in a display surface direction of said plasma display panel.

5. A plasma display device according to claim 1, wherein said each sub-cell is configured to have a different electrode area of said each surface discharge electrode pair opposite to said discharge gas space of said sub-cell.

6. A plasma display device according to claim 2, wherein said each sub-cell is configured to have a different electrode area of said each surface discharge electrode pair opposite to said discharge gas space of said sub-cell.

7. A plasma display device according to claim 1, wherein said each surface discharge electrode pair opposing said each sub-cell is made of different material.

8. A plasma display device according to claim 2, wherein said each surface discharge electrode pair opposing said each sub-cell is made of different material.

9. A plasma display device according to claim 1, wherein a portion of each said sub-cell of said first substrate corresponding to said discharge gas space has a different light transmissivity.

10. A plasma display device according to claim 2, wherein a portion of each said sub-cell of said first substrate corresponding to said discharge gas space has a different light transmissivity.

11. A plasma display device according to claim 1, wherein a portion of each said sub-cell of said second substrate corresponding to said discharge gas space has a different light reflectivity.

12. A plasma display device according to claim 2, wherein a portion of each said sub-cell of said second substrate corresponding to said discharge gas space has a different light reflectivity.

13. A plasma display device according to claim 1, wherein two of said discharge gaps between said each scanning electrode of said each surface discharge electrode pair and two of said discharge sustain electrodes placed on both sides of said scanning electrode cause two of said sub-cells to emit light, respectively.

14. A driving method for use in plasma display device comprising a plasma display panel which includes:
a first substrate and a second substrate disposed opposite to each other;
a plurality of surface discharge electrode pairs disposed on a surface of said first substrate opposite to said second substrate, and each composed of a scanning electrode and a discharge sustain electrode disposed in parallel with each other across a discharge gap;
a plurality of data electrodes disposed on a surface of said second substrate opposite to said first substrate to intersect with said each surface discharge electrode pair;
a plurality of unit cells each formed in each of intersecting regions of said plurality of surface discharge electrode pairs with said plurality of data electrodes; and
a discharge gas space including said each unit cell and formed by filling a discharge gas between said first substrate and said second substrate,
wherein said plasma display device divides one frame period of a display screen displayed in gradation by said plurality of unit cells into a plurality of sub-fields weighted based on luminance levels, and sets in each of said sub-field periods a scanning period in which a scanning pulse is sequentially applied to said scanning electrodes and simultaneously a display data pulse synchronized to the scanning pulse is applied to said data electrodes to produce an address discharge in selected ones of said unit cells, a discharge sustain period in which a discharge sustain pulse is alternately applied to said discharge sustain electrodes and said scanning electrodes to drive said unit cells to emit light, a pre-discharge period for producing a sustain erasure discharge for said unit cells which emit light in the discharge sustain period, and a priming discharge for all said unit cells,
said method characterized by composing each said unit cell of a plurality of sub-cells, and changing an applied voltage waveform of the discharge sustain pulse from one to another of said sub-cells to set a light emission luminance produced by one discharge sustain pulse in one or more of said sub-cells to be lower than the light emission luminance of the other sub-cells.

15. A driving method for use in plasma display device comprising a plasma display panel which includes:
a first substrate and a second substrate disposed opposite to each other;
a plurality of surface discharge electrode pairs disposed on a surface of said first substrate opposite to said second substrate, and each composed of a scanning electrode and a discharge sustain electrode disposed in parallel with each other across a discharge gap;
a plurality of data electrodes disposed on a surface of said second substrate opposite to said first substrate to intersect with said each surface discharge electrode pair;
a plurality of unit cells each formed in each of intersecting regions of said plurality of surface discharge electrode pairs with said plurality of data electrodes; and
a discharge gas space including said each unit cell and formed by filling a discharge gas between said first substrate and said second substrate,
wherein said plasma display device divides one frame period of a display screen displayed in gradation by said plurality of unit cells into a plurality of sub-fields weighted based on luminance levels, and sets in each of said sub-field periods a scanning period in which a scanning pulse is sequentially applied to said scanning electrodes and simultaneously a display data pulse synchronized to the scanning pulse is applied to said data electrodes to produce an address discharge in selected ones of said unit cells, a discharge sustain period in which a discharge sustain pulse is alternately applied to said discharge sustain electrodes and said scanning electrodes to drive said unit cells to emit light, a pre-discharge period for producing a sustain erasure discharge for said unit cells which emit light in the discharge sustain period, and a priming discharge for all said unit cells,
said method characterized by composing each said unit cell of a plurality of sub-cells, and changing a sub-cell which is driven to emit light from one to another of said sub-fields to set a light emission luminance produced by one discharge sustain pulse in one or more of said sub-cells to be lower than the light emission luminance of the other sub-cells.

16. A driving method according to claim 15, wherein said each unit cell is composed of two sub-cells, two of said discharge gaps between said each scanning electrode of said each surface discharge electrode pair and two of said discharge sustain electrodes placed on both sides of said scanning electrode cause two of said sub-cells to emit light, respectively, and a sub-cell driven to emit light is changed from one to another of said sub-fields to set a light emission luminance produced by one discharge sustain pulse in one or more of said sub-cells to be lower than the light emission luminance of the other sub-cells.

17. A driving method according to claim 16, characterized by setting a luminance level of the sub-field having the highest luminance assigned to a darker sub-cell of said two sub-cells to be lower than a luminance level of the sub-field having the lowest luminance assigned to a brighter sub-cell.

18. A driving method according to claim 17, wherein the ratio of the luminance level of the sub-field having the lowest luminance assigned to the brighter sub-cell to the luminance level of the sub-field having the highest luminance assigned to the darker sub-cell is approximately 2:1.

19. A driving method according to claim 14, wherein said priming discharge in said each sub-field is produced in the sub-cell having the lowest light emission luminance produced by one discharge sustain pulse.
